(19) United States
(12) Patent Application Publication
(10) Pub. No.: US 2005/0268672 A1
(43) Pub. Date: Dec. 8, 2005

(54) Security container

(76) Inventors: Anthony Henry Joseph Fraser, Peterborough (GB); Peter Antony Farrar, Leeds (GB)

Correspondence Address: DICKSTEIN SHAPIRO MORIN & OSHINSKY LLP, 2101 L Street, NW, Washington, DC, 20037, US

(21) Appl. No.: 10/525,043

(22) PCT Filed: Aug. 20, 2003
(86) PCT No.: PCT/GB03/03648

§ 371 Date: Feb. 18, 2005

(30) Foreign Application Priority Data
Aug. 20, 2002 (GB) 0219374.6

(51) Int. Cl. E05B 65/00

(52) U.S. Cl. 70/57.1; 70/63; 340/568.1

(57) ABSTRACT

An over container (1) for providing a security housing for a primary container (2), the over container (1) being adapted to receive or contain the primary container (2) and having an EAS tag (7) therein such that, when in a locked configuration, neither the primary container (2) nor the tag (7) can be removed and, when in an unlocked configuration, the over container (1) can be opened to allow the primary container (2) to be removed, the over container (1) being provided with a locking device (3) having first and second arms (3B, 3C) which, in the locked position, hold the over container in a closed configuration and which, in the unlocked position, enable the over container (1) to be opened, the locking device having a retaining arm (5) which, when the locking device (3) is in the locked position, acts to retain the locking device (3) in this position and which is releasable upon application of a predetermined magnetic field from release apparatus.

### TECHNICAL FIELD

This invention relates to security containers for containing goods, for instance whilst they are on display in a retail outlet. It also relates to security devices for installing therein and to containers adapted to receive such security devices.

### BACKGROUND ART

Security containers for housing information storage media, e.g. CDs and DVDs, are known. WO02/39451 describes various forms of apparatus for holding information storage media and security devices for use therewith and the contents thereof is incorporated herein. WO02/39451 is primarily concerned with a security device arranged to lock a CD or DVD container in a closed configuration. The security device preferably carries alarm triggering means, such as an Electronic Article Surveillance (EAS) label or tag. Once the security device has been released, it may be withdrawn from the container (with the alarm triggering means) for disposal or re-use in another CD or DVD container, so the container can be freely opened and closed to permit access to the CD or DVD therein and the purchaser can then take the container away from the retail outlet without triggering the alarm.

An alternative way of securing CD or DVD containers is to house them, complete with their existing containers, in a lockable overbox which is known in the trade as a ‘safer’. Alarm triggering means are housed within the overbox and, when the goods are purchased by a customer, the retailer unlocks the overbox and removes the CD or DVD container housed therein for the customer to take away. The overbox is retained in the store for re-use.

The present Invention provides another form of security container or overbox.

### SUMMARY OF INVENTION

According to a first aspect of the invention, there is provided an over container for providing a security housing for a first container, the over container being adapted to receive or contain the first container and having alarm triggering means therein such that, when in a locked configuration, neither the first container nor the alarm triggering means can be removed therefrom and, when in an unlocked configuration, the over container can be opened to allow the first container to be removed therefrom, the over container being provided with a locking device having first and second arms which, in a locked position, respectively engage parts of the over container so as to hold the over container in a closed configuration and which, in an unlocked position, enable said parts to be moved to an open configuration, the locking device having retaining means which, when the locking device is moved to the locked position, acts to retain the locking device in this position and which is releasable upon application of a predetermined magnetic field thereto.

The over container may be arranged to be a snug-fit around the first container. Alternatively, the over container may be provided with locating means for locating and/or holding the first container therein.

According to another aspect of the invention, there is provided a security container arranged or used as an overbox, the security container being adapted to receive or contain predetermined goods and having alarm triggering means therein such that, when in a locked configuration, neither the goods nor the alarm triggering means can be removed therefrom and, when in an unlocked configuration, the container can be opened to allow the goods to be removed therefrom, the container being provided with a locking device having first and second arms which, in a locked position, respectively engage parts of the container so as to hold the container in a closed configuration and which, in an unlocked position, enable said parts to be moved to an open configuration, the locking device having retaining means which, when the locking device is moved to the locked position, acts to retain the locking device in this position and which is releasable upon application of a predetermined magnetic field thereto. Preferably, a security container such as that described in WO02/39451 is arranged or used as an overbox, and has a security device which is insertable therein to lock the box in a closed configuration.

According to a further aspect of the invention there is provided a security container adapted to receive or contain predetermined goods other than information storage media directly and having alarm triggering means therein such that, when in a locked configuration, neither the goods nor the alarm triggering means can be removed therefrom and, when in an unlocked configuration, the container can be opened to allow the goods to be removed therefrom, the container being provided with a locking device having first and second arms which, in a locked position, respectively engage parts of the container so as to hold the container in a closed configuration and which, in an unlocked position, enable said parts to be moved to an open configuration, the locking device having retaining means which, when the locking device is moved to the locked position, acts to retain the locking device in this position and which is releasable upon application of a predetermined magnetic field thereto. Preferably a security container such as that described in WO02/39451. For example, goods such as a watch, necklace or other jewellery may be housed in the container. Preferably, the security container is provided with locating means for locating and/or holding the goods therein.

Preferably, the security device, whilst being movable between locked and unlocked positions, cannot be removed from the over container. In a preferred embodiment, the security device comprises a resilient tab which is orientated so as to flex as it passes through a slot when the security device is first installed in the container but is unable to pass through the slot in the opposite direction and so prevents the security device being withdrawn completely from the container. Alternatively, the security device may comprise a slot located over a pin provided in the over container such that the security device can be slid back and forth but held captive by said pin.

The invention also relates to a security device per se for use in a security container as described above.

The invention also relates to a container or over container per se adapted to receive a security device of the type claimed and described herein.

Preferably, the security device is similar to that shown and described in relation to FIGS. 1-3, 11 or 23 of WO02/39451 although the longer arm thereof may be shorter as it does not need to interact with disk holding means.

Preferably, the security device comprises a locking mechanism similar to that shown and described in relation to FIGS. 11-15 and FIGS. 19A-19B of WO02/39451.

Preferably, the security device is such as to be releasable from the locked position thereof by release apparatus similar to that shown and described in relation to FIGS. 34-37 of WO02/39451. Alternatively, the release apparatus may be of a modified form similar to that described in GB2371597A, e.g. as shown and described in relation to FIGS. 6 and 7 thereof. The disclosure of GB2371597A is incorporated herein.

The security container or overbox preferably has an EAS tag or label affixed thereto. This may be an acousto-magnetic (AM) device, for instance in the form of a label or strip applied to an inner surface of the container or to part of the security device so that it cannot be removed by a potential thief when the container is locked in a closed configuration.

Alternatively, a radio frequency (RF) device may be used, e.g. in the form of a flat coil of wire which acts as a transponder. Such coils typically have a diameter of around 50 mm so, in some cases, it may be desirable to locate the goods held by the container off-centre or towards one side of the container to provide more room for the coil. In another arrangement, the transponder may comprise a coil wound around a ferrite core. In some cases, it may be desirable to mount such a transponder in a part of the security device, e.g. as described in GB0215397.1 and PCT/GB2003/002885 the disclosure of which is incorporated herein. These disclose arrangements in which the transponder is mounted within the head of the security device so it is located adjacent an external edge of the container.

Other features of the invention will be apparent from the following description.

### BRIEF DESCRIPTION OF DRAWINGS

The invention will now be further described, merely by way of example, with reference to the accompanying drawings in which:

FIGS. 1A and 1B show perspective views of a security container according to a first embodiment of the invention used as an over-box for a jewel box; FIG. 1A showing a security device thereof in a locked position and FIG. 1B showing the security device in an unlocked position; and

FIG. 1C shows a perspective view of the security device itself;

FIGS. 2A and 2B shows perspective views of a security container according to a second aspect of the invention used to house goods, such as a watch, directly; FIG. 2A showing a security device thereof in a locked position and FIG. 2B showing the security device in an unlocked position; and

FIG. 2C shows a perspective view of the security device itself (which is the same as that shown in FIG. 1C);

FIGS. 3A, 3B and 3C are cross-sections taken on line A-A of FIG. 1A or FIG. 2A showing the security device in three positions;

FIGS. 4A, 4B and 4C are perspective views of a security container according to a second embodiment of the invention used as an over-box: FIG. 4A shows the container, with two primary containers therein, secured in a closed position by a security device; FIG. 4B shows the container in an open position following removal of the security device (viewed from a different direction to FIG. 4A) and FIG. 4C shows the container as in FIG. 4B but without the two primary containers therein but with a security device inserted therein; and

FIGS. 5A and 5B are perspective views of a security container according to a third embodiment of the invention used as an over-box: FIG. 5A shows the container secured in a closed position by a security device and FIG. 5B shows the container in an open position, following release of the security device, with two primary containers and other items therein.

### BEST MODE OF THE INVENTION

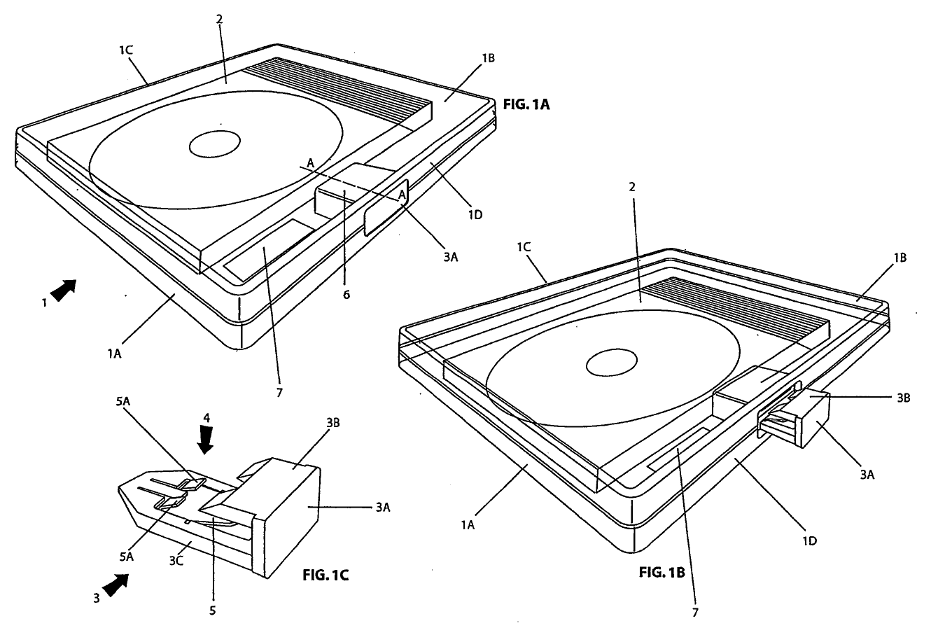

FIG. 1A shows a container 1 comprising a base portion 1A and a lid portion 1B hinged along side 1C generally similar to that described in WO02/39451 but without disk holding means and instead shaped so as to hold a conventional jewel box 2 therein.

A security device 3 as shown in FIG. 1C is inserted into the opening side 1D of the container to lock it in the closed position. The security device 3 comprises a head portion 3A, a first arm 3B and a second arm 3C and is similar to that shown in FIG. 23 of WO02/39451 except that the longer arm 3C thereof is much shorter as, in this embodiment, it does not interact with disk holding means (or other means within the container) nor does it carry an EAS label. Instead, an EAS label 7 is provided within the container 1 (on an internal surface thereof).

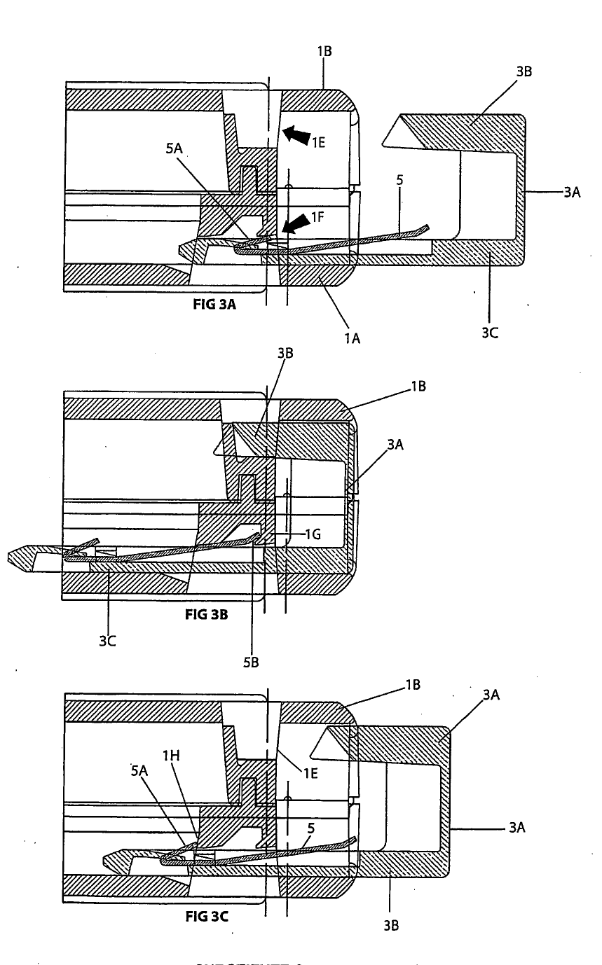

The security device 3 has a locking mechanism 4 comprising a metal pivot arm 5. This is similar to the pivot arm described in WO02/39451 but is provided with additional, upstanding, movement limiting tabs 5A the function of which will be described below with reference to FIG. 3.

In the embodiment shown in FIGS. 1A and 1B, the container also has a cover 6 formed therein for covering the part of the security device 3 located within the container 1.

FIG. 1C shows the security device prior to installation in the container. FIG. 1A shows the security device when inserted in the container so as to hold the container in a closed position, the two arms 3B and 3C being fitted within slots in the lid and base portion 1B and 1A, respectively. The EAS label 7 is thus also locked within the container.

Once the locking mechanism 4 has been released, the security device 3 can be partially withdrawn from the container 1 until the first arm 3B is withdrawn from the lid portion 1B and so allows the lid portion 1B to be opened.

As will be described below, the security device 3 is preferably arranged so that it cannot be withdrawn from the position shown in FIG. 1B so it is held captive. Once the jewel box 2 has been removed and given to a customer, the container 1 can thus be re-used as a cover box for another jewel box.

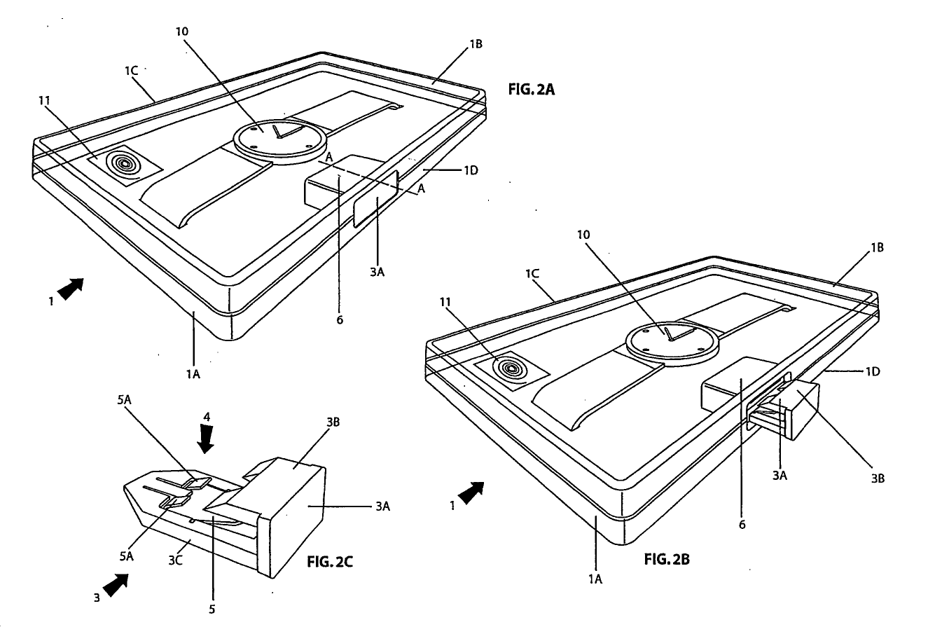

FIGS. 2A, 2B and 2C show a similar arrangement to FIGS. 1A, 1B and 1C except that the container directly houses goods, such as a watch 10, rather than acting as a cover box. Preferably, the container is adapted to hold the watch 10 in place or is provided with an insert, e.g. a sheet cardboard with slots therein, for holding the watch in place. When the watch is sold, it may be removed from the container so the container can be re-used in the store. Alternatively, the container may be given to the customer as a presentation case for the watch. In the latter case, the security device would need to be of a form that could be removed entirely or put into a state in which the locking mechanism is inactive, e.g. as shown and described in relation to FIGS. 12 and 13 of WO02/39451. FIGS. 2A and 2B show an RF alarm triggering device 11 in the form of a flat coil mounted within the container 1.

The containers shown in FIGS. 1 and 2 are preferably shaped so as to be able to be inserted into the same release apparatus as the store uses for unlocking DVD containers as described in WO02/39451. Alternatively, the release apparatus may be designed to accommodate a range of different size containers, e.g. as described in GB2371597A or designed to receive containers of any shape having the type of security device described herein installed therein. In other situations, it may be acceptable for separate release apparatus to be used for containers of other shapes and/or sizes.

FIGS. 3A, 3B and 3C respectively show the security device 3 when it is first installed in the container 1, when it is in the locked position and when it is partially withdrawn so as to enable the lid portion 1B to be opened.

FIGS. 3A-3C show the head portion 3A and first and second arms 3B and 3C of the security device and the pivot arm 5 carried by the second arm 3C. They also show the extra movement limiting tabs 5A thereof. The Figures also show part of the lid and base portions 1B and 1A of the containers 1 and slots 1E and 1F with which the arms 3B and 3C engage respectively.

In FIG. 3A, the security device 3 is being inserted into the container and the tabs 5A are flexed as it passes through the slot 1F.

In FIG. 3B, the security device 3 is in the locked position with arm 3B within slot 1E and arm 3C within slot 1F. An end 5B of the pivot arm 5 engages a detent 1G within the container to prevent withdrawal of the security device 3.

When the container 1 is inserted into release apparatus, a further inward force is applied to the security device 3 via the head portion 3A and a magnetic field is applied to the pivot arm 5 to move it out of engagement with the detent 1G whereby the security device 3 can be withdrawn to the position shown in FIG. 3C. In this position, the first arm 3B is withdrawn from slot 1E so the lid portion 1B can be opened. However, tab 5A engage a further detent 1H in the container and prevent the security device 3 from being withdrawn completely from the container.

Other arrangements may be used to prevent complete withdrawal of the security tag from the container. The security device 3 may, for instance, have a slot (not shown) in arm 3C which fits over a pin (not shown) in the container such that the security device 3 can be slid back and forth on the pin but is held captive thereby.

The security container 1 is preferably formed of a tough plastics material which is difficult for a potential thief to break inconspicuously, e.g. a tough polycarbonate.

Preferably, at least part of the container is of clear plastics material so the contents can be easily seen therethrough.

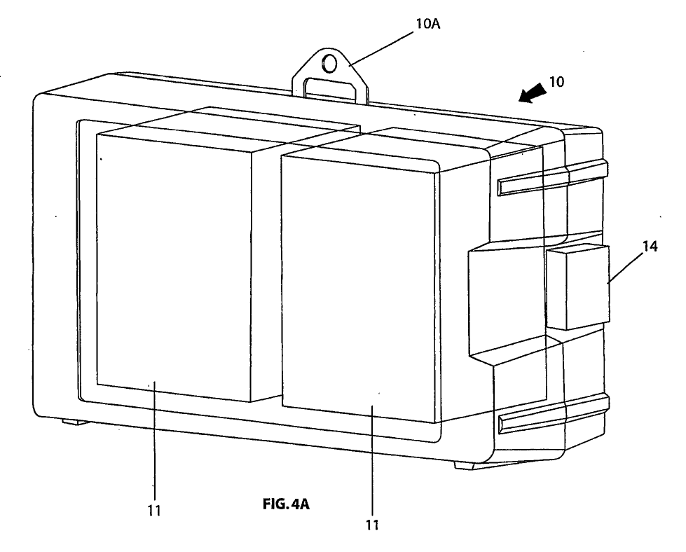

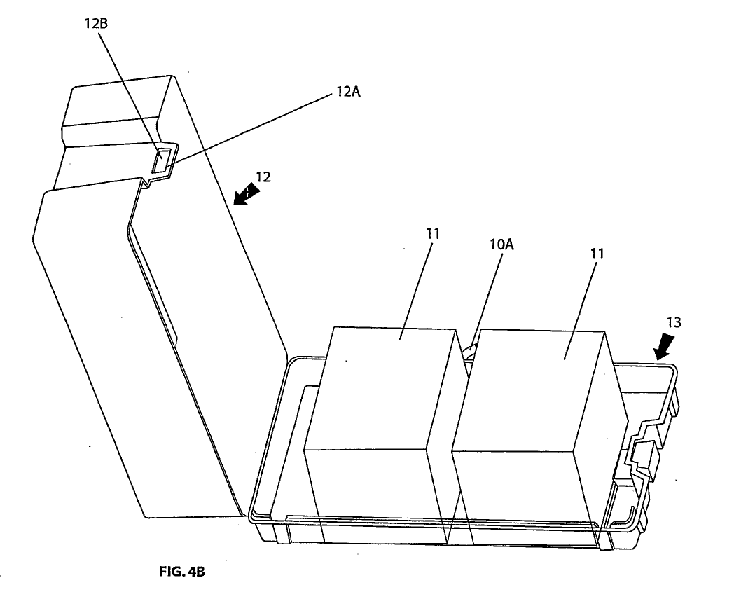

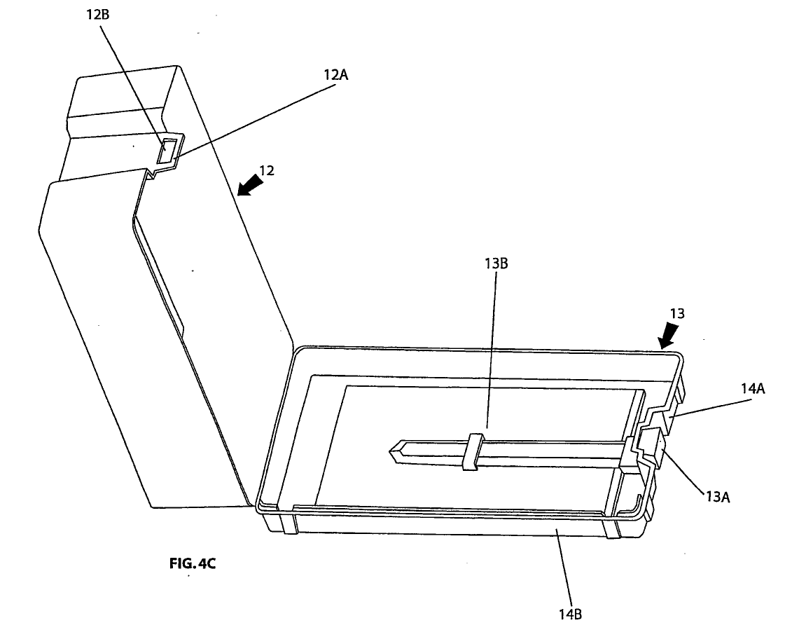

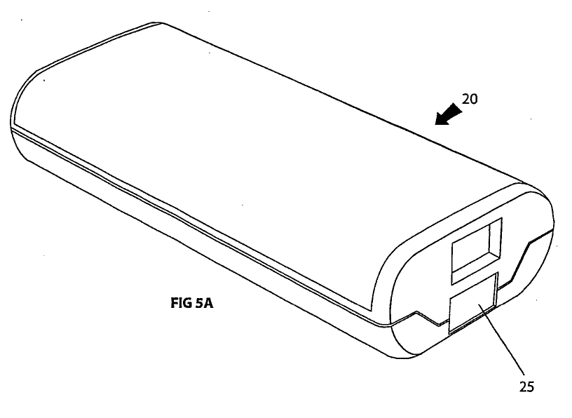

FIGS. 4A-4C shows perspective views of another embodiment of the invention which provides an overbox 10 for housing one or more primary containers 11.

As shown in FIG. 4B, the overbox 10 comprises a lid portion 12 and a base portion 13 hinged together at one edge. The lid and base portion are shaped to located and house specific goods therein, for example medical or pharmaceutical products housed within parallelpiped primary containers such as cardboard cartons 11. The overbox 10 also acts as a display case and is provided with an apertured tab 10A to allow it to be hung on a display rack.

The container 10 is adapted to receive a security device 14 of the type described above, e.g. of the type disclosed in FIGS. 1-3, 11 or 23 of WO02/39451. Specifically, the lid portion 12 is provided with a projection 12A which defined a slot 12B therein for receiving one arm 14A of the security device 14 and the base portion 13 is provided with a slot 13A for receiving a second arm 14B of the security device 14. As shown in FIG. 4C, the base portion 13 may also have a slot 13B for receiving and locating a distal end of the second arm 14B.

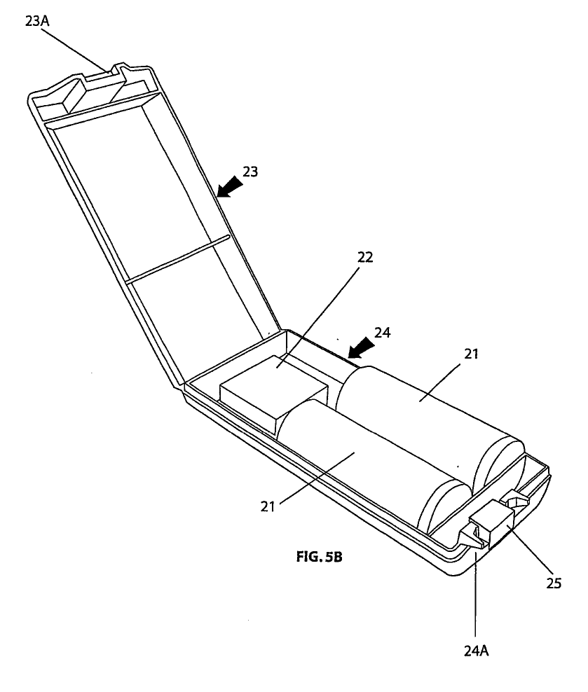

FIGS. 5A and 5B show a further embodiment of the invention which provides an overbox 20 for housing one or more primary containers 21 as well as other goods 22. In this case, the overbox is shaped to house two cylindrical primary containers 21, for example plastic capsules containing medicaments. The overbox 20 comprises a lid portion 23 hinged to a base portion 24. The lid portion 23 has a recessed area 23A for receiving a first arm of a security device 25 and the base portion 24 has a slot 24A for receiving a second arm of the security device 25.

As indicated above, the containers and overboxes described above may be arranged so the security device can be released by the same type of release apparatus used in a retail outlet to release similar security devices in other products, e.g. CD or DVD containers. To enable this, the security device preferably comprises a head portion from which first and second arms extend and which is arranged so that, in the locked position, the head portion is located externally of the container adjacent a first side thereof and has metal retaining means which are located internally of the container adjacent a second side thereof, the second side extending substantially perpendicular to the first side. The release apparatus operates by engaging the head portion to push the security device slightly further into the container whilst applying a magnetic field to move the retaining means to an unlocked position whereupon the security device can be at least partially withdrawn from the container so as to permit the container to be opened.

The security device functions to secure the container or over-container in the closed position. The security device may also interact with the goods and/or with locating means for locating the goods in the container so as to inhibit movement of the goods. The security device may, for instance, lie over the goods and/or may block access to the goods and/or locating means so as to inhibit removal of the goods. Alternatively, or additionally, the security device may inhibit removal of the locating means (and hence of the goods mounted thereon) from the container.

The present invention is not restricted to the details of the embodiments described above. The security device, and the locking mechanism used therein, may for instance be modified or other forms of security device or locking mechanism used although, preferably, the principles of operation thereof are similar to those described above.

The security container described above can be used as an over container for a wide variety of goods which are already housed in a primary container. Alternatively, it can be used to directly house a variety of other goods. In both cases, it enables the products to be displayed in a retail outlet but provides a level of security which helps deter or prevent theft of the goods from the store.

1. An over container for providing a security housing for a primary container, the over container being adapted to receive or contain the primary container and having alarm triggering means therein such that, when in a locked configuration, neither the primary container nor the alarm triggering means can be removed therefrom and, when in an unlocked configuration, the over container can be opened to allow the primary container to be removed therefrom, the over container being provided with a locking device having first and second arms which, in a locked position, respectively engage parts of the over container so as to hold the over container in a closed configuration and which, in an unlocked position, enable said parts to be moved to an open configuration, the locking device having retaining means which, when the locking device is moved to the locked position, acts to retain the locking device in this position and which is releasable upon application of a predetermined magnetic field thereto.

2. An over container as claimed in claim 1 arranged to be a snug-fit around the primary container.

3. An over container as claimed in claim 1 provided with locating means for locating and/or holding the primary container therein.

4. An over container as claimed in claim 1 in which the security device is moveable between a locked position and an unlocked position but cannot be removed from the over container.

5. An over container as claimed in claim 4 in which the security device comprises resilient means arranged to flex in one direction to permit the security device to be installed in the container but not in an opposite direction so as to prevent the security device being withdrawn completely from the over container.

6. An over container as claimed in claim 5 in which the resilient means comprises a tab arranged to be able to pass through a slot in the container in one direction as the security is first installed in the container but to be unable to pass through the slot in the opposite direction.

7. An over container as claimed in claim 1 in which the security device comprises a head portion and first and second arms projecting substantially parallel to each other from the head portion.

8. An over container as claimed in claim 7 having a base portion adapted to receive the first arm of the security device and a lid portion adapted to receive the second arm thereof.

9. An over container a claimed in claim 7 in which the first arm is longer than the second arm.

10. An over container as claimed in claim 9 in which the first arm is provided with the retaining means.

11. An over container as claimed in claim 10 in which the first arm, when the security device is in the locked position, extends into the over container so as to interact with the primary container and/or with locating means for locating the primary container so as to inhibit removal of the primary container from the over container.

12. An over container as claimed in claim 1 in which the retaining means comprises a pivot arm and a detent which, in the locked position, are engaged with each other and which are arranged to be moved out of engagement with each other upon application of a predetermined magnetic field thereto.

13. An over container as claimed in claim 1 in which the alarm triggering means is secured to an inner surface of the over container.

14. An over container as claimed in claim 1 in which the alarm triggering means is secured to part of the security device which is inaccessible when the container is locked in the closed configuration.

15. An over container as claimed in claim 1 in which the alarm triggering means comprises an electronic article surveillance (EAS) tag.

16. An over container as claimed in claim 1 adapted to contain a conventional “jewel box” type of CD container.

17. A security container arranged or used as an overbox, the security container being adapted to receive or contain predetermined goods and having alarm triggering means therein such that, when in a locked configuration, neither the goods nor the alarm triggering means can be removed therefrom and, when in an unlocked configuration, the container can be opened to allow the goods to be removed therefrom, the container being provided with a locking device having first and second arms which, in a locked position, respectively engage parts of the container so as to hold the container in a closed configuration and which, in an unlocked position, enable said parts to be moved to an open configuration, the locking device having retaining means which, when the locking device is moved to the locked position, acts to retain the locking device in this position and which is releasable upon application of a predetermined magnetic field thereto.

18. A security container as claimed in claim 17 having locating means for locating and/or holding said predetermined goods therein.

19. A security container as claimed in claim 18 in which the security device is arranged, when in the locked position, to interact with said predetermined goods and/or with said locating means so as to inhibit movement of said predetermined goods away from the locating means.

20. An over container or security container as claimed in claim 17 in which the security device comprises a head portion from which the first and second arms extend and arranged such that, when in the locked position, the head portion is located externally of the container adjacent a first side thereof and the retaining means is located internally of the container adjacent a second side thereof extending substantially perpendicular to the first side.

21. A security device adapted for use with a container or over container as claimed in claim 17.

22. A security device as claimed in claim 21 comprising a head portion and having first and second arms extending substantially parallel to each other from the head portion.

23. A security device as claimed in claim 22 in which the first arm is longer than the second arm.

24. A security device as claimed in claim 23 in which the first arm is provided with retaining means moveable between a locked position and an unlocked position upon application of a predetermined magnetic field.

25. A security device as claimed in claim 21 having movement limiting means which permit insertion of the security device into a container but prevent it being completely withdrawn therefrom.

26. A security device as claimed in claim 25 in which the movement limiting means comprises a resilient tab able to pass through a slot in one direction but not in the opposite direction.

27. A security container adapted to receive or contain predetermined goods other than information storage media directly and having alarm triggering means therein such that, when in a locked configuration, neither the goods nor the alarm triggering means can be removed therefrom and, when in an unlocked configuration, the container can be opened to allow the goods to be removed therefrom, the container being provided with a locking device having first and second arms which, in a locked position, respectively engage parts of the container so as to hold the container in a closed configuration and which, in an unlocked position, enable said parts to be moved to an open configuration, the locking device having retaining means which, when the locking device is moved to the locked position, acts to retain the locking device in this position and which is releasable upon application of a predetermined magnetic field thereto.

28. A container or over container adapted to receive a security device as claimed in claim 21 so as to form a container or over container.
